(19) United States
(12) Patent Application Publication
(10) Pub. No.: US 2025/0321331 A1
(43) Pub. Date: Oct. 16, 2025

(54) Navigation Sensor

(71) Applicant: SICK AG, Waldkirch (DE)

(72) Inventor: Patric BEINSCHOB, Hamburg (DE)

(21) Appl. No.: 19/174,293

(22) Filed: Apr. 9, 2025

(30) Foreign Application Priority Data
Apr. 12, 2024 (DE) 102024110236.5

(51) Int. Cl. G01S 13/08; G01S 13/86

(52) U.S. Cl. CPC G01S 13/08; G01S 13/865

(57) ABSTRACT

A navigation sensor determines a coordinate data set including a spatial position and/or a location and/or a movement of the navigation sensor or of a movable object connected to the navigation sensor in space. The navigation sensor includes an object detection sensor configured to periodically scan a monitored zone, a base unit, and a scanning unit rotatably supported at the base unit. The scanning unit has a transmission device configured to transmit transmission signals into a monitored zone and a reception device that is configured for receiving reception signals, which are generated by objects present in the monitored zone by a remission of incident transmission signals, and for converting the reception light signals into electrical reception signals. An evaluation unit is connected to the object detection sensor and is configured to determine the coordinate data set at least on the basis of the electrical reception signals.

The present invention relates to a navigation sensor for determining a coordinate data set that comprises a spatial position and/or a location and/or a movement of the navigation sensor or of a movable object connected to the navigation sensor in space. The navigation sensor comprises an object detection sensor that is configured for periodically scanning a monitored zone and that comprises a base unit and a scanning unit rotatably supported at the base unit. The scanning unit has a transmission device that is configured for transmitting transmission signals into a monitored zone and a reception device that is configured for receiving reception signals, which are generated by objects present in the monitored zone by a remission of incident transmission signals, and for converting the reception signals into electrical reception signals. The navigation sensor further comprises an evaluation unit that is connected to the object detection sensor and that is configured to determine the coordinate data set at least on the basis of the electrical reception signals.

In the field of automation technology, movable apparatus, such as mobile robots, self-driving conveying apparatus or self-driving vehicles, are increasingly being used that can move autonomously or in a controlled manner in space in one or more dimensions. For a safe operation of such robots or conveying apparatus, it is necessary that they can be localized in space.

For this purpose, navigation sensors of the category are provided that can be arranged at a movable object, e.g. a robot arm, a robot platform or a conveying apparatus, and that are configured to determine a coordinate data set that enables the localization of the navigation sensor or of the movable object connected to the navigation sensor.

Depending on the degrees of freedom in which the movable object connected to the navigation sensor can move, the coordinate data set can comprise the position, i.e. the location in space, in one, two or three dimensions, the location, i.e. the orientation in space, in one, two or three dimensions and, if necessary, also their temporal derivatives, i.e., for example, a linear movement and/or a rotational movement in one, two or three dimensions. The time derivatives can refer both to the first derivative, i.e. linear velocities and/or angular velocities, and to the second derivative, i.e. linear accelerations and/or angular accelerations. The representation of the coordinate data set can take place in a suitable local or global coordinate system.

The localization of the navigation sensor or of the movable object connected thereto primarily takes place by means of an object detection sensor that can, for example, be configured as an optoelectronic sensor, preferably as a laser scanner or as a LIDAR (“light imaging, detection and ranging”, refers to a form of three-dimensional laser scanning), or also as a radar sensor (“radio detection and ranging”, refers to a form of radio-based direction measurement and distance measurement).

In a laser scanner, a light beam generated by a laser or a light pulse sequence periodically sweeps over a monitoring plane or scanning plane by means of a deflection unit. The transmission signals emitted in the form of transmission light are reflected by possibly present objects (in particular, for example, diffusely reflected) and are evaluated by the evaluation unit after reception in the reception device and conversion into corresponding electrical reception signals. In an object detection sensor designed as a radar sensor, the transmission signals are emitted in the form of bundled electromagnetic waves in the radio frequency range and are remitted to possibly present objects (in particular, for example, diffusely reflected) and, after reception in the reception device and conversion into corresponding electrical reception signals, are evaluated by the evaluation unit. The deflection unit is formed by a base unit and a scanning unit rotating at the base unit. The position of a detected object can be determined from the angular position of the scanning unit relative to the base unit and from the signal transit time of the transmission signals between the transmission by the transmission device and the reception in the reception device. A monitoring in a plurality of scanning planes or in three dimensions can e.g. be achieved by designing the object detection sensor as a multi-plane scanner with a plurality of scanning beams or as a LIDAR system or radar system in which an additional pivoting of the transmission light beam or of the radar beam about a pivot axis extending perpendicular to the axis of rotation of the deflection unit is provided. In an object detection sensor configured as an optoelectronic sensor, the detection of the reception light signals in the reception device can take place in a non-spatially resolving manner, e.g. by means of a single photodiode, or in a spatially resolving manner, e.g. by means of a line sensor or an image sensor. In an object detection sensor configured as an optoelectronic sensor, the transmission light signals can be emitted in both the visible and non-visible range (ultraviolet or infrared range).

An exemplary optoelectronic sensor is described in EP 3 736 603 B1.

Due to the scanning of a two- or three-dimensional spatial region by means of the object detection sensor, an image of the scene or environment can so-to-say be generated by means of the evaluation unit, in which scene or environment the navigation sensor or the movable object is located or moves. In real operation, the localization can, however, be disturbed at times due to unsuitable environmental conditions. For example, a localization in corridors or tunnels can be impaired due to a lack of clarity of the environment. A temporary partial or total obscuring of the field of view of the object detection sensor by foreign objects or by environmental influences such as dust or fog can also impair the localization or even make it impossible.

To be able to bridge such disruptions, the optical navigation or localization can be supplemented with additional navigation means that can compensate for temporary failures or malfunctions of the optical or radar-based navigation. For this purpose, distance meters can, for example, be used that are, for example, coupled to drive wheels and can record their angles of rotation and/or angular velocities. The distance traveled during a failure of the optical navigation can hereby also be coupled and the current location can thereby be determined.

Furthermore, apparatus that can detect movements or changes in movement in accordance with the principle of inertial navigation can also be used. However, such inertial navigation systems are often expensive and time-consuming to calibrate.

It is the object of the invention to further develop a navigation sensor of the initially mentioned kind in a cost-effective manner such that temporary failures or malfunctions of the object detection sensor can be compensated or bridged.

The object is satisfied by a navigation sensor having the features of claim 1. According to the invention, it is provided that at least one inertial measurement unit connected to the evaluation unit is arranged at the scanning unit and is configured to detect accelerations and/or angular velocities of the rotating scanning unit and to transmit corresponding acceleration signals and/or angular velocity signals to the evaluation unit, and that the evaluation unit is configured to additionally determine the coordinate data set on the basis of the acceleration signals and/or angular velocity signals.

An inertial measurement unit is a combination of a plurality of motion sensors that can detect accelerations and/or angular velocities in one, two or three dimensions, wherein the accelerations and/or angular velocities are determined based on the principle of mass inertia. Changes in position, e.g. linear movements, or changes in location, e.g. rotations, can be determined by integrating the acceleration signals or the angular velocity signals, for example. Such inertial measurement units, also called IMUs, are commercially available, sometimes at very low cost, depending on the functional principle and the desired precision. For, example, failures of the object detection sensor, for instance due to unfavorable environmental conditions such as dust, rain, snow or a lack of contrast due to insufficient lighting or missing contours in the scene detected by the object detection sensor, which do not allow or falsify a detection of the environment of the navigation sensor, can be compensated by the combination of the object detection sensor and the initial measurement unit.

Due to the arrangement of the inertial measurement unit on the rotating scanning unit, forces or accelerations have an effect during the operation of the navigation sensor even when the navigation sensor or a movable object connected thereto is at rest, i.e. in a stationary position and location. Due to the rotation of the inertial measurement unit, a kind of offset or a rest signal is superposed on the output signals of the inertial measurement unit, which prevents a suppression of output signals near the zero point. In many designs of inertial measurement units, such a zero-point suppression is namely provided as standard to prevent the generation of faulty output signals when the inertial measurement unit or a device equipped therewith is at rest and the motion sensors of the IMU only provide low signal levels near the zero point. With this zero-point suppression, signals are filtered out that are below defined threshold values and that may also fulfill other criteria. Such a zero-point suppression can be easily circumvented by arranging the inertial measurement unit at the rotating scanning unit and in particular without any adjustments to the circuit of the inertial measurement unit, wherein the signal levels rise to a level above the threshold values due to the rotation. This avoids having to resort to costly custom-made designs of inertial measurement units in which such a zero-point suppression is not provided or is at least deactivated.

Depending on the specific arrangement and orientation of the inertial measurement unit relative to the scanning device, the centrifugal forces occurring during the rotation of the scanning unit only act on some of the individual sensor components of the inertial measurement unit so that the desired offset may possibly not be generated for all the partial sensors. If this cannot be tolerated depending on the respective application, the inertial measurement unit can be oriented with respect to the axis of rotation of the scanning unit such that all the movement vectors that can be detected by the inertial measurement unit are at least partially oriented in the direction of the centrifugal force vector or such that none of the respective detectable movement vectors of the inertial measurement unit extend exactly perpendicular to the centrifugal force vector.

According to an advantageous embodiment, the navigation sensor comprises a rotational speed sensor that is connected to the evaluation unit and that is configured for determining the rotational frequency of the scanning unit relative to the base unit, wherein the evaluation unit is configured to determine corrected acceleration signals and/or angular velocity signals that are corrected on the basis of the rotational frequency and to determine the coordinate data set on the basis of the corrected acceleration signals and/or angular velocity signals, wherein the determination of the corrected acceleration signals and/or angular velocity signals comprises reducing the acceleration signals and/or the angular velocity signals by those signal components which are solely due to the rotation of the scanning unit. Said rotational speed sensor can, for example, be a separate rotational speed sensor or a processing unit that determines the rotational frequency of the scanning unit from a control signal for a motor driving the scanning unit. This processing unit can, for example, be designed as a logic unit within the evaluation unit. As a rule, however, the angular position of the scanning unit relative to the base unit is known anyway or is detected by means of an angular position encoder of the object detection sensor since said angular position serves as the basis for the optoelectronic or radar-based determination of the coordinate data set. In particular, the corrected acceleration signals and/or angular velocity signals only comprise the acceleration components and/or angular velocity components that are due to a movement of the navigation sensor. If the navigation sensor, or more precisely the base unit, is at rest, the corrected acceleration signals and/or angular velocity signals have a value of zero.

According to a further advantageous embodiment, the inertial measurement unit comprises at least one angular rate sensor and/or at least one acceleration sensor. Both sensor types are preferably integrated in an inertial measurement unit or assembly.

According to a further advantageous embodiment, the at least one angular rate sensor and/or the at least one acceleration sensor is/are formed by at least one microelectromechanical system. Such microelectromechanical systems are also designated as MEMS for short. Such MEMS are designed for mass use and are used in large quantities, for example, in mobile devices such as smartphones or tablets. Due to the resulting high production volumes, inertial measurement units in which one or more MEMS are integrated are available at very low unit costs. Frequently, such MEMS-based inertial measurement units—as initially explained—have a zero-point suppression that cannot be deactivated as standard. The arrangement at the rotating scanning unit now allows the disadvantages associated with the zero-point suppression to be overcome that would have a negative effect in the case of an assumed stationary arrangement of the inertial measurement unit, for example at the base unit.

According to a further advantageous embodiment, the optoelectronic sensor is configured to determine the distance of a detected object present in the monitored zone, preferably in accordance with the principle of signal transit time measurement, i.e. the time of flight/transit time of the light signals or radar wave signals. Alternatively, the determination of the object distance can also take place in accordance with the phase shift principle.

Further advantages of the navigation sensor according to the invention and advantageous embodiments result from the following description of the drawings. An embodiment example of the invention is shown in the drawing. The drawing, the description and the claims include numerous features in combination. The skilled person will also expediently consider these features individually and combine them into sensible further combinations. There are shown:

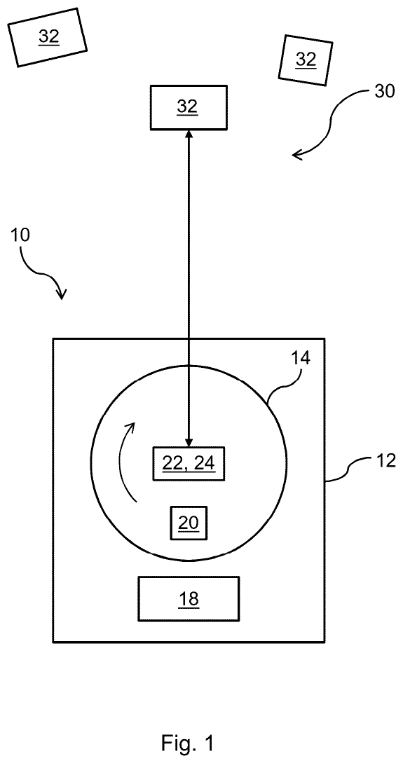

FIG. 1 a schematic representation of a navigation sensor according to an embodiment example.

FIG. 1 shows a navigation sensor 10 according to an embodiment example that is configured for determining a coordinate data set. The coordinate data set can comprise a spatial position and/or a location and/or a movement of the navigation sensor or a movable object connected to the navigation sensor 10 in space (not shown). The navigation sensor 10 comprises an object detection sensor that is, for example, designed as an optoelectronic sensor and that is configured to periodically scan a monitored zone 30. The object detection sensor comprises a base unit 12 and a scanning unit 14 rotatably supported at the base unit. Drive means for rotatingly driving the scanning unit 14 are not shown in the schematic representation of FIG. 1.

A transmission device 22 that is configured for transmitting transmission light signals into the monitored zone 30 and a reception device 24 that is configured for receiving reception light signals, which are generated by environmental objects 32 present in the monitored zone 30 by a remission of incident transmission signals, are arranged at the rotating scanning unit 14. The transmission device 22, for example a laser or a laser diode, and the reception device 24, which, for example, comprises a photodiode, a line sensor or an image sensor, are integrated in a common assembly in the embodiment example. Both the transmission device 22 and the reception device 24 can comprise one or more respective optics. In addition, even further optical elements such as deflection elements, beam splitters or filters can also be provided.

The description in the previous paragraph refers to an embodiment using an optoelectronic sensor.

An inertial measurement unit 20 is additionally arranged at the scanning unit 14. As indicated by the curved arrow, the inertial measurement unit 20 rotates together with the transmission device 22 and the reception device 24. The inertial measurement unit 20 is configured to detect accelerations and/or angular velocities of the rotating scanning unit 14. Both the inertial measurement unit 20 and the transmission device 22 and the reception device 24 are connected to an evaluation unit 18 that is arranged at the base unit 12 in the embodiment example. The transmission of signals between the evaluation unit 18 and the assemblies arranged at the scanning unit 14 can take place both in a wired and a wireless manner.

The evaluation unit 18 is configured to determine the spatial position, the location and/or movements of the navigation sensor in space on the basis of the electrical reception signals that are generated by the reception device 24 and that represent a scene image of the monitored zone 30. If an optical determination of this coordinate data set is temporarily not possible, changes in the spatial position, the location and/or the movement of the navigation sensor 10 can be detected by means of the inertial measurement unit 20, wherein the determination of the coordinate data set then temporarily takes place only on the basis of these acceleration signals or angular velocity signals recorded by the inertial measurement unit 20.

To determine the corrected acceleration signals and/or angular velocity signals that are solely due to the relative movement of the navigation sensor 10 in space, those signal components which are solely due to the rotation of the inertial measurement unit 20 can be determined both by calculation, while considering the distance of the inertial measurement unit 20 from the axis of rotation of the rotating scanning unit 14 and the rotational speed of the scanning unit 14, or experimentally as part of a calibration process. These rotation-related signal components can then be subtracted from the signals that are measured by the inertial measurement unit 20 in real operation to determine the corrected acceleration signals and/or angular velocity signals. This correction expediently takes place vectorially, while considering the vector directions of the detected or generated forces or accelerations.

### REFERENCE NUMERAL LIST

10 navigation sensor
12 base unit
14 scanning unit
18 evaluation unit
20 inertial measurement unit
22 transmission device
24 reception device
30 monitored zone
32 environmental object

1. A navigation sensor for determining a coordinate data set that comprises at least one of a spatial position, a location and a movement of the navigation sensor or of a movable object connected to the navigation sensor in space, said navigation sensor comprising
an object detection sensor that is configured for periodically scanning a monitored zone and that comprises a base unit and a scanning unit rotatably supported at the base unit, wherein the scanning unit has a transmission device that is configured for transmitting transmission signals into a monitored zone and a reception device that is configured for receiving reception signals, which are generated by environmental objects present in the monitored zone by a remission of incident transmission signals, and for converting the reception signals into electrical reception signals,
an evaluation unit that is connected to the object detection sensor and that is configured to determine the coordinate data set at least on the basis of the electrical reception signals,
at least one inertial measurement unit connected to the evaluation unit, the at least one inertial measurement unit is arranged at the scanning unit and is configured to detect accelerations and/or angular velocities of the rotating scanning unit and to transmit corresponding acceleration signals and/or angular velocity signals to the evaluation unit, and
wherein the evaluation unit is configured to additionally determine the coordinate data set on the basis of the acceleration signals and/or angular velocity signals.

2. The navigation sensor according to claim 1,
wherein the navigation sensor comprises a rotational speed sensor that is connected to the evaluation unit and that is configured for determining the rotational frequency of the scanning unit relative to the base unit, and
wherein the evaluation unit is configured to determine corrected acceleration signals and/or angular velocity signals that are corrected on the basis of the rotational frequency and to determine the coordinate data set on the basis of the corrected acceleration signals and/or angular velocity signals, wherein the determination of the corrected acceleration signals and/or angular velocity signals comprises reducing the acceleration signals and/or the angular velocity signals by those signal components which are solely due to the rotation of the scanning unit.

3. The navigation sensor according to claim 1,
wherein the inertial measurement unit comprises at least one angular rate sensor and/or at least one acceleration sensor.

4. The navigation sensor according to claim 3,
wherein the at least one angular rate sensor and/or the at least one acceleration sensor is/are formed by at least one microelectromechanical system.

5. The navigation sensor according to claim 1,
wherein the object detection sensor is configured as an optoelectronic sensor.

6. The navigation sensor according to claim 5,
wherein the optoelectronic sensor is configured as a laser scanner or a LIDAR sensor.

7. The navigation sensor according to claim 1,
wherein the object detection sensor is configured as a RADAR sensor.

8. The navigation sensor according to claim 1,
wherein the object detection sensor is configured to determine the distance of a detected environmental object present in the monitored zone.

9. The navigation sensor according to claim 1,
wherein the object detection sensor is configured to determine the distance of a detected environmental object present in the monitored zone in accordance with the principle of signal transit time measurement.
